(19) United States
(12) Patent Application Publication
(10) Pub. No.: US 2025/0229755 A1
(43) Pub. Date: Jul. 17, 2025

(54) HYDRAULIC PRESSURE GENERATING DEVICE

(71) Applicant: Honda Motor Co., Ltd., Tokyo (JP)

(72) Inventor: Eisuke HORII, Tokyo (JP)

(73) Assignee: Honda Motor Co., Ltd., Tokyo (JP)

(21) Appl. No.: 18/963,818

(22) Filed: Nov. 29, 2024

(30) Foreign Application Priority Data
Jan. 17, 2024 (CN) 202410068276.7

(51) Int. Cl. B60T 8/1755; B60T 8/40; B60T 13/66

(52) U.S. Cl. CPC B60T 8/1755; B60T 8/4081; B60T 13/662

(57) ABSTRACT

A hydraulic pressure generating device includes a cylinder; a plurality of pistons displaced within the cylinder; a pressure chamber communicating with hollow portions formed in the pistons and formed in the cylinder, so that a brake fluid generates a hydraulic pressure corresponding to the displacement of the pistons; a reservoir storing the brake fluid and communicating with the inside of the cylinder through a discharge port; a plurality of first communication holes formed on peripheral walls of the hollow portions and switched between a communication state and a non-communication state with the discharge port through the displacement of the pistons; and a second communication hole formed on the peripheral walls of the hollow portions, located on a rear side of the first communication holes in a traveling direction of the pistons, and switched between the communication state and the non-communication state with the discharge port.

### CROSS-REFERENCE TO RELATED APPLICATION

This application claims the priority benefit of China application serial no. 202410068276.7, filed on Jan. 17, 2024. The entirety of the above-mentioned patent application is hereby incorporated by reference herein and made a part of this specification.

### BACKGROUND

### Technical Field

The disclosure relates to a hydraulic pressure generating device, and in particular, relates to a hydraulic pressure generating device capable of shortening the time required for a brake hydraulic pressure to rise and improving the responsiveness of braking force generation.

### Description of Related Art

In an electric booster type brake system, an electric hydraulic pressure generating device uses an electric motor to drive a piston installed in a cylinder that can slide forward and backward to generate brake hydraulic pressure. However, by driving the electric motor, the piston starts to advance until brake hydraulic pressure is generated in the cylinder, so there is a loss stroke of the piston. Therefore, the problem of reduced responsiveness of braking force generation is caused. To be specific, when the piston starts to advance from the initial position and the valve closes, brake hydraulic pressure is generated in the cylinder. However, when the piston begins to advance until the valve closes, no brake fluid pressure is generated, and during which time the piston's advance distance becomes the loss stroke.

Patent Literature 1 (Japanese Patent Publication No. JP 4953832B) aims to make it possible to easily adjust the initial position of the piston of the brake hydraulic pressure generating device while minimizing the loss stroke of the piston. Therefore, the brake hydraulic pressure generating device has an adjustment member configured to adjust the initial position of the piston in the axial direction. The responsiveness of braking force generation is improved by minimizing the loss stroke between the start of the piston's forward movement and the generation of brake hydraulic pressure. This eliminates the need to control the actuator and adjust the initial position each time the piston is operated.

### Problems to Be Addressed by the Disclosure

Regarding Patent Literature 1, although the initial position can be easily adjusted, the brake hydraulic pressure is not generated until all the valves are closed after the piston starts to advance. Therefore, there is a problem in shortening the time required for the brake hydraulic pressure to rise. In recent years, the responsiveness of electric brakes has received much attention, requiring rapid boosting during emergency braking.

### Solution to Problems

In order to solve the above problem, the disclosure provides a hydraulic pressure generating device capable of shortening the time required for a brake hydraulic pressure to rise and improving the responsiveness of braking force generation.

### SUMMARY

According to the technical solution of an embodiment of the disclosure, the disclosure provides a hydraulic pressure generating device including a cylinder, a plurality of pistons, a pressure chamber, a reservoir, a plurality of first communication holes, and a second communication hole. The plurality of pistons are linked to a brake pedal and displaced within the cylinder through an electric motor as the brake pedal moves. The pressure chamber communicates with hollow portions formed in the pistons and is formed in the cylinder, so that a brake fluid generates a hydraulic pressure corresponding to the displacement of the pistons. The reservoir stores the brake fluid and communicates with the inside of the cylinder through a discharge port. The plurality of first communication holes are formed on peripheral walls of the hollow portions and are switched between a communication state and a non-communication state with the discharge port through the displacement of the pistons. The second communication hole is formed on the peripheral walls of the hollow portions of the pistons on which the first communication holes are provided, located on a rear side of the first communication holes in a traveling direction of the pistons, and switched between the communication state and the non-communication state with the discharge port. Herein, a total flow rate of the brake fluid that flows through the second communication hole per unit time is less than a total flow rate of the brake fluid that flows through the first communication holes per unit time. In an initial state of the hydraulic pressure generating device, the first communication holes are in the non-communication state, and the second communication hole is in the communication state.

In an embodiment of the disclosure, a controller configured to control a driving amount of the electric motor is further provided. The controller is configured to: enable the pistons to move to positions where the first communication holes and the discharge port become the communication state and then return to the initial state when the pistons return to the initial state from a pressurized state.

In an embodiment of the disclosure, the hydraulic pressure generating device further includes a vehicle stability assist configured to support stabilization of a vehicle behavior and a wheel brake cylinder. Herein, the pressure chamber is connected to the wheel brake cylinder through the vehicle stability assist. The controller is configured to: move the pistons to the positions where the first communication holes and the discharge port become the communication state when the vehicle stability assist operates.

In the hydraulic pressure generating device provided by an embodiment of the disclosure, the total flow rate of the brake fluid that flows through the second communication hole provided in each of the plurality of pistons is the same per unit time.

### Effects of the Disclosure

The hydraulic pressure generating device provided by the embodiments of the disclosure has at least the following technical effects:

In the initial state, the second communication hole communicates with the discharge port to maintain the atmosphere open state. Since the total flow rate of the brake fluid that can flow through the second communication hole per unit time is less than the total flow rate of the brake fluid that can flow through the first communication holes per unit time, less brake fluid flows out, the loss stroke can be shortened, and hydraulic pressure is easier to build up. The loss stroke herein refers to the time required for the brake hydraulic pressure to rise after the valve is closed, not the stroke amount of the piston.

By temporarily establishing a state in which the first communication holes and the discharge port are in communication, the pressure in the pressure chamber is reduced to the atmosphere open state in a short time.

When the vehicle stability assist operates, the first communication holes and the discharge port become the communication state, so more brake fluid is allowed to flow to one side of the vehicle stability assist than in the initial state, thereby allowing the vehicle stability assist to operate smoothly.

The timing of applying pressure to each pressure chamber may be matched, and the timing of applying brakes may be matched.

To make the aforementioned more comprehensible, several embodiments accompanied with drawings are described in detail as follows.

### BRIEF DESCRIPTION OF THE DRAWINGS

FIG. 1 is a schematic view of a hydraulic pressure generating device according to an embodiment of the disclosure.

FIG. 2 is an enlarged schematic view of a portion A of FIG. 1.

FIG. 3 is a schematic side view of a piston according to an embodiment of the disclosure.

FIG. 4 is a schematic side view of the piston according to another embodiment of the disclosure.

FIG. 5 is a schematic view of operations of the piston according to the embodiments of the disclosure.

FIG. 6 is a graph showing a relationship between piston stroke and time in the hydraulic pressure generating device according to the operations of the piston in FIG. 5, where the vertical axis is the piston stroke and the horizontal axis is time (seconds).

### DESCRIPTION OF THE EMBODIMENTS

Hereinafter, exemplary embodiments of the disclosure are to be described based on the drawings. Note that in each of the embodiments to be described in the following paragraphs, the same reference numerals are assigned to the common parts, so that repeated description may not to be provided. Hereinafter, embodiments of the disclosure are described with reference to the drawings.

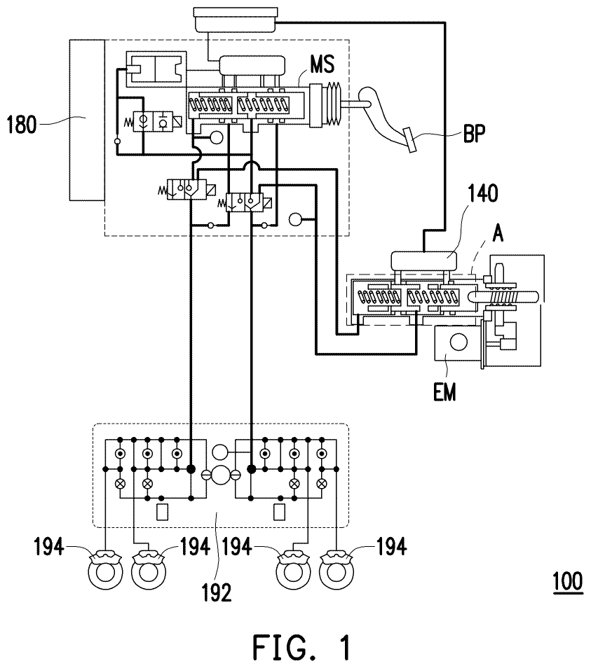

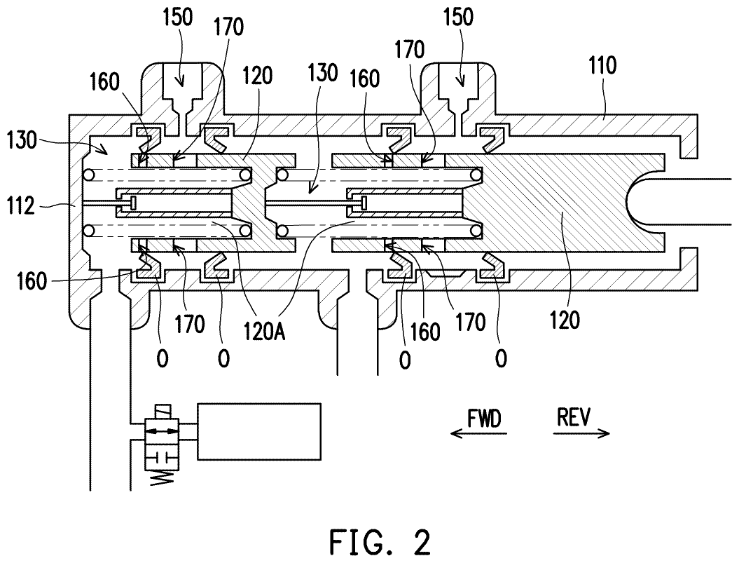

FIG. 1 is a schematic view of a hydraulic pressure generating device according to an embodiment of the disclosure. FIG. 2 is an enlarged schematic view of a portion A of FIG. 1. In FIG. 2, an arrow FWD indicates the front, and an arrow REV indicates the rear.

With reference to FIG. 1 and FIG. 2 together, a hydraulic pressure generating device 100 may include a cylinder 110, pistons 120, a pressure chamber 130, a reservoir 140, a discharge port 150, a first communication hole 160, and a second communication hole 170. Hereinafter, the detailed structure of the hydraulic pressure generating device 100 is further described.

The plurality of pistons 120 are linked to a brake pedal BP and are displaced within the cylinder 110 through an electric motor EM as the brake pedal BP moves.

The pressure chamber 130 communicates with hollow portions 120A formed in the pistons 120 and is formed in the cylinder 110, so that a brake fluid generates a hydraulic pressure corresponding to the displacement of the pistons 120.

With reference to FIG. 2, sealing members O are provided on an inner peripheral wall of the cylinder 110. The sealing members O may be annular sealing structures. The pressure chamber 130 located on the left side of FIG. 2 is a space defined by the sealing members O and a side wall 112 of the cylinder 110, and the pressure chamber 130 located in the middle of FIG. 2 is a space divided by two sealing members O and O.

The reservoir 140 stores the brake fluid and communicates with the inside of the cylinder 110 through the discharge port 150.

A plurality of first communication holes 160 are formed on peripheral walls of the hollow portions 120A and switched between a communication state and a non-communication state with the discharge port 150 through the displacement of the pistons 120.

The second communication hole 170 is formed on the peripheral walls of the hollow portions 120A of the pistons 120 on which the first communication holes 160 are provided, located on a rear side of the first communication holes 160 in a traveling direction of the pistons 120, and switched between the communication state and the non-communication state with the discharge port 150. Herein, a total flow rate of the brake fluid that can flow through the second communication hole 170 per unit time is less than a total flow rate of the brake fluid that can flow through the first communication holes 160 per unit time. In an initial state of the hydraulic pressure generating device 100, the first communication holes 160 are in the non-communication state, and the second communication hole 170 is in the communication state.

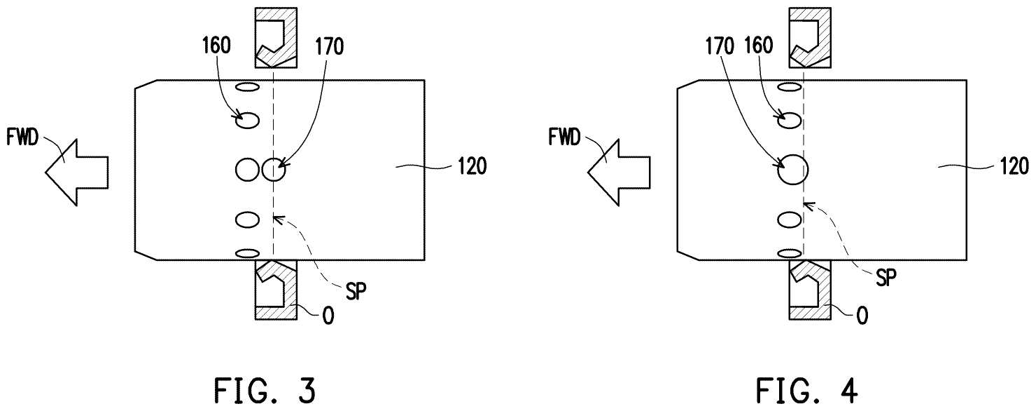

FIG. 3 is a schematic side view of a piston according to an embodiment of the disclosure. With reference to FIG. 3, which illustrates that the piston 120 is in the initial state (non-operating state) and is located in a sealing position SP. In FIG. 3, the second communication hole 170 is located on the rear side of the first communication hole 160 in the traveling direction of the piston 120 (arrow FWD in FIG. 3).

FIG. 4 is a schematic side view of the piston according to another embodiment of the disclosure. With reference to FIG. 4, which illustrates that the piston 120 is in the initial state (non-operating state) and is located in the sealing position SP. In FIG. 4, the second communication hole 170 has a shape in which a portion of a radius is large. For instance, the second communication hole 170 may be a long hole, an oval hole, or a rectangular hole. In FIG. 4, in the initial state, at least a portion of the second communication hole 170 is provided at a position communicating with the discharge port 150 on the rear side of the sealing position SP (with reference to FIG. 2). Herein, the rear side of the sealing position SP refers to the rear side opposite to the traveling direction of the arrow FWD in FIG. 4.

In the embodiments of FIG. 3 and FIG. 4, the number of the second communication hole 170 is one, but the number of the second communication hole 170 is not limited in the disclosure. In other embodiments, the number of the second communication hole 170 may also be plural. When the number of the second communication hole 170 is smaller, the loss stroke is smaller, and accordingly, an appropriate number of second communication holes 170 may be provided.

Further, the total flow rate of the brake fluid that can flow through the first communication holes 160 per unit time refers to the total flow rate flowing through the plurality of first communication holes 160 per unit time. Moreover, the total flow rate of the brake fluid that can flow through the second communication hole 170 per unit time refers to the total flow rate flowing through at least one second communication hole 170 per unit time.

As described above, in the initial state, the second communication hole 170 communicates with the discharge port 150 to maintain an atmosphere open state. Since the total flow rate of the brake fluid that can flow through the second communication hole 170 per unit time is less than the total flow rate of the brake fluid that can flow through the first communication holes 160 per unit time, less brake fluid flows out, the loss stroke can be shortened, and hydraulic pressure is easier to build up.

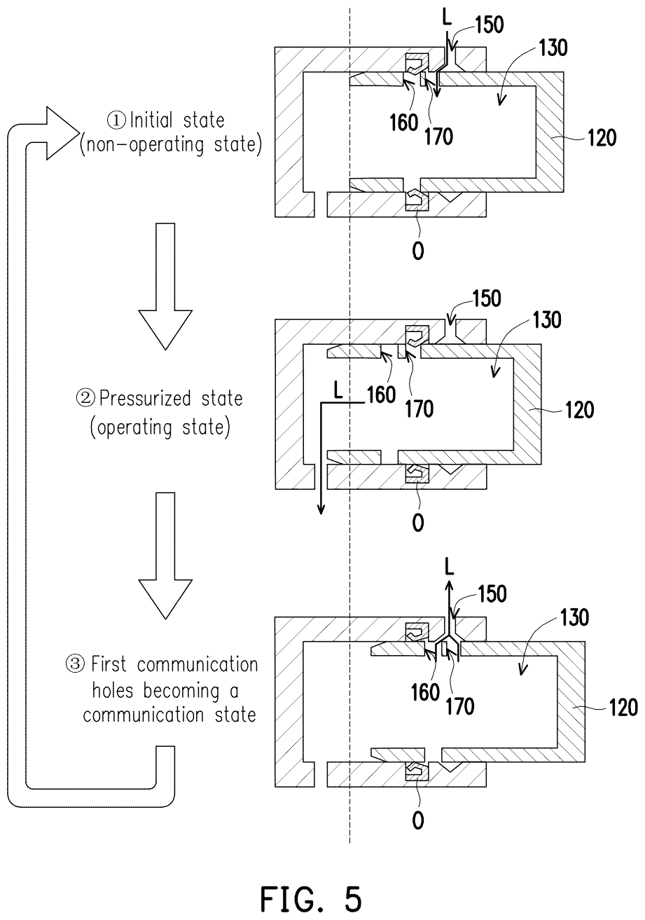

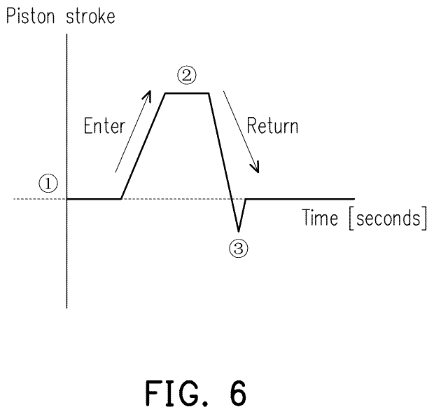

FIG. 5 is a schematic view of operations of the piston according to the embodiments of the disclosure. FIG. 6 is a graph showing a relationship between piston stroke and time in the hydraulic pressure generating device according to the operations of the piston in FIG. 5, where the vertical axis is the piston stroke and the horizontal axis is time (seconds).

With reference to FIG. 1, FIG. 5, and FIG. 6, the hydraulic pressure generating device 100 may further include a controller 180 configured to control a driving amount of the electric motor EM. The controller 180 is configured as follows. When the piston 120 returns from a pressurized state (state \textcircled{2} as shown in FIG. 5) to the initial state (state \textcircled{1} as shown in FIG. 5), the piston 120 moves to a position where the first connecting hole 160 and the discharge port 150 become the communication state (state \textcircled{3} as shown in FIG. 5) and then returns to the initial state (state \textcircled{1} as shown in FIG. 5).

In FIG. 5, an arrow L shows the flow of the brake fluid.

Further, an entry process of the piston 120 (from state \textcircled{1} to state \textcircled{2} and a return process of the piston 120 (from state \textcircled{2} to state \textcircled{3} is shown in FIG. 6. During the return process, a slope of the piston stroke changes greatly.

As described above, by temporarily establishing a state in which the first communication holes 160 and the discharge port 150 are in communication, the pressure in the pressure chamber 130 may be reduced to the atmosphere open state in a short time.

With reference to FIG. 1 and FIG. 5, the hydraulic pressure generating device 100 may further include a vehicle stability assist 192 configured to support stabilization of a vehicle behavior and a wheel brake cylinder 194. Herein, the pressure chamber 130 is connected to the wheel brake cylinder 194 through the vehicle stability assist 192. The controller 180 is configured to move the pistons 120 to positions where the first communication holes 160 and the discharge port 150 become the communication state when the vehicle stability assist 192 is activated.

As described above, when the vehicle stability assist 192 operates, the first communication holes 160 and the discharge port 150 become the communication state, so more brake fluid (arrow L in state 3 shown in FIG. 5) is allowed to flow to one side of the vehicle stability assist 192 than in the initial state, thereby allowing the vehicle stability assist 192 to operate smoothly.

With reference to FIG. 2 again, in the hydraulic pressure generating device 100 provided in the embodiments of the disclosure, the total flow rate of the brake fluid that can flow through the second communication hole 170 provided in each of the plurality of pistons 120 is the same per unit time.

As described above, the timing of applying pressure to each pressure chamber 130 may be matched, and the timing of applying brakes may be matched.

In the hydraulic pressure generating device 100 provided by the embodiments of the disclosure, when a master cylinder MS and the cylinder 110 generating the brake hydraulic pressure when a driver depresses the brake pedal (braking operation) are provided separately (as shown in FIG. 1 and FIG. 2), the driver's braking operation is converted into an electrical signal to operate the cylinder 110. Further, the brake hydraulic pressure generated by the cylinder 110 is used to operate the wheel brake cylinder 194 to form a brake by wire (BBW) structure. In addition, in other embodiments, the master cylinder MS and the cylinder 110 may also be directly connected (not shown) to form a direct-acting brake by wire structure.

In view of the foregoing, the hydraulic pressure generating device provided by the embodiments of the disclosure has at least the following technical effects:

In the initial state, the second communication hole communicates with the discharge port to maintain the atmosphere open state. Since the total flow rate of the brake fluid that can flow through the second communication hole per unit time is less than the total flow rate of the brake fluid that can flow through the first communication holes per unit time, less brake fluid flows out, the loss stroke can be shortened, and hydraulic pressure is easier to build up.

By temporarily establishing a state in which the first communication holes and the discharge port are in communication, the pressure in the pressure chamber may be reduced to the atmosphere open state in a short time.

When the vehicle stability assist operates, the first communication holes and the discharge port become the communication state, so more brake fluid is allowed to flow to one side of the vehicle stability assist than in the initial state, thereby allowing the vehicle stability assist to operate smoothly.

The timing of applying pressure to each pressure chamber may be matched, and the timing of applying brakes may be matched.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A hydraulic pressure generating device, comprising:
a cylinder;
a plurality of pistons linked to a brake pedal and displaced within the cylinder through an electric motor as the brake pedal moves;
a pressure chamber communicating with hollow portions formed in the pistons and formed in the cylinder, so that a brake fluid generates a hydraulic pressure corresponding to the displacement of the pistons;
a reservoir storing the brake fluid and communicating with the inside of the cylinder through a discharge port;
a plurality of first communication holes formed on peripheral walls of the hollow portions and switched between a communication state and a non-communication state with the discharge port through the displacement of the pistons; and
a second communication hole formed on the peripheral walls of the hollow portions of the pistons on which the first communication holes are provided, located on a rear side of the first communication holes in a traveling direction of the pistons, and switched between the communication state and the non-communication state with the discharge port,
wherein
a total flow rate of the brake fluid that flows through the second communication hole per unit time is less than a total flow rate of the brake fluid that flows through the first communication holes per unit time, and
in an initial state of the hydraulic pressure generating device, the first communication holes are in the non-communication state, and the second communication hole is in the communication state.

2. The hydraulic pressure generating device according to claim 1, further comprising:
a controller configured to control a driving amount of the electric motor,
the controller is configured to:
enable the pistons to move to positions where the first communication holes and the discharge port become the communication state and then return to the initial state when the pistons return to the initial state from a pressurized state.

3. The hydraulic pressure generating device according to claim 2, further comprising:
a vehicle stability assist configured to support stabilization of a vehicle behavior; and
a wheel brake cylinder,
wherein the pressure chamber is connected to the wheel brake cylinder through the vehicle stability assist,
the controller is configured to:
move the pistons to the positions where the first communication holes and the discharge port become the communication state when the vehicle stability assist operates.

4. The hydraulic pressure generating device according to claim 1, wherein
the total flow rate of the brake fluid that flows through the second communication hole provided in each of the plurality of pistons is the same per unit time.
